(19) United States
(12) Patent Application Publication
(10) Pub. No.: US 2023/0136888 A1
(43) Pub. Date: May 4, 2023

(54) ASYNCHRONOUS TRANSACTION PROCESSING

(71) Applicant: Check Technologies, Inc., New York, NY (US)

(72) Inventors: Vivek Patel, Brooklyn, NY (US); Ian Zapolsky, San Francisco, CA (US); Bryant Su, Arlington, VA (US)

(21) Appl. No.: 17/535,243

(22) Filed: Nov. 24, 2021

Related U.S. Application Data
(60) Provisional application No. 63/273,576, filed on Oct. 29, 2021.

(51) Int. Cl. G06Q 20/38; G06Q 20/40; G06F 16/955; H04L 9/32

(52) U.S. Cl. CPC G06Q 20/389; G06Q 20/401; G06F 16/955; H04L 9/3236

(57) ABSTRACT

Aspects of the present disclosure relate to asynchronous transaction processing. In examples, a transaction between a sender and a recipient may utilize any of a variety of associated transaction information to complete the transaction. However, identifying issues associated with completing the transaction (e.g., before, during, and/or after) may be difficult, especially given that information associated with the transaction may change, become out of date, or be unavailable. Accordingly, a resource platform may generate callback indications as information changes and to provide an indication as to the status of transaction processing, among other examples. In some instances, the resource platform may generate a dynamic status for a sender, a recipient, or other entity according to associated information, which may similarly result in a callback indication. Thus, callback indications generated by the resource platform may enable improved information handling and transaction processing, among other benefits.

### CROSS-REFERENCE TO RELATED APPLICATION

This application claims priority to U.S. Provisional Application No. 63/273,576, titled “Asynchronous Transaction Processing,” filed on Oct. 29, 2021, the entire disclosure of which is hereby incorporated by reference in its entirety.

### BACKGROUND

In examples, a transaction for a resource is processed to transfer the resource from a sender to a recipient. However, visibility into such transactions may be limited, which may result in processing delays (e.g., as a result of incorrect transaction information or resource availability), frustration on the part of the sender and/or the recipient, and unintended system behavior (e.g., as may result from an inability to identify and resolve issues), among other detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to asynchronous transaction processing. In examples, a transaction between a sender and a recipient may utilize any of a variety of associated transaction information to complete the transaction. However, identifying issues associated with completing the transaction (e.g., before, during, and/or after) may be difficult, especially given that information associated with the transaction may change, become out of date, or be unavailable. Accordingly, a resource platform may generate callback indications as information changes and to provide an indication as to the status of transaction processing, among other examples. In some instances, the resource platform may generate a dynamic status for a sender, a recipient, or other entity according to associated information, which may similarly result in a callback indication. Thus, callback indications generated by the resource platform may enable improved information handling and transaction processing, among other benefits.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for asynchronous transaction processing.

FIG. 2A illustrates an overview of an example method for generating a callback indication associated with asynchronous transaction processing.

FIG. 2B illustrates an overview of an example method for processing a callback indication associated with asynchronous transaction processing.

FIG. 3 illustrates an overview of an example method for processing a callback indication from a third-party service by a resource platform according to aspects described herein.

FIG. 4 illustrates an overview of an example method for generating a dynamic status associated with a customer according to aspects described herein.

FIG. 5 illustrates an overview of an example method for configuring a callback indication with which aspects of asynchronous transaction processing may be performed.

FIG. 6 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, processing a transaction for a resource may be performed using transaction information (e.g., associated with a sender and/or a recipient) and/or in view of a set of conditions. Example resources include, but are not limited to, data, access to computing resources (e.g., processing time, memory, or storage), physical items, services, money, or currency. For example, periodic transactions may be used by a sender to provide a predetermined set of resources to a recipient, as may be the case when the disclosed resource platform is used to perform aspects of payroll processing between an employer (e.g., the sender) and an employee (e.g., the recipient). In such an example, the set of resources may include monetary payment and/or a set of employment benefits, among other examples. A transaction may be a recurring transaction or may be a one-off transaction, among other examples.

However, visibility into transactions may be limited, such that it may be difficult or impossible to determine when the transaction is completed, why a transaction failed if the transaction was not completed, and/or when the transaction information is in a state that is usable to complete a transaction accordingly, among other examples. Returning to the above example, an employee may not have completed an onboarding process, such that the transaction information that would be used to complete a transaction associated with the employee may be unavailable or incorrect when the resource platform processes transactions for the sender. These and other issues may result in processing delays, user frustration, and/or unintended system behavior, among other detriments.

Accordingly, aspects of the present application relate to asynchronous transaction processing, where a resource platform provides asynchronous transaction processing for any of a variety of customers. In examples, a customer may be a sender or, as another example, a customer may provide transaction processing services for any number of senders (e.g., as may be the case when the sender utilizes the resource platform to provide such services accordingly). As is described in greater detail below, the resource platform may facilitate resource transactions and provide associated callback indications to a customer device, thereby providing an improved user experience, enabling transaction status to be tracked, and permitting issues to be addressed as they arise, among other benefits.

As used herein, a callback indication may be a webhook or an application programming interface (API) call, among other examples. As an example, callback target information may be used to provide a generated callback indication, which may include a uniform resource locator (URL) to which the callback indication should be directed. In some instances, the callback indication may further comprise a cryptographic signature or hash, thereby enabling the recipient to verify its content. For example, it may be verified that the callback indication originated from the resource platform and/or that the content of the callback indication is correct. In examples, an acknowledgement and/or information may be received in response to a callback indication. As an example, if the callback indication indicates that additional information is needed, the response may comprise at least a part of the requested additional information.

Example callback indication content includes, but is not limited to, an indication of an update to customer information, an indication that additional information is needed by the resource platform, and/or an indication that a transaction has succeeded, is paused, or has failed, among other examples. In examples, a callback indication includes at least a part of the associated customer information, such as a snapshot of associated information for which the callback indication was generated. Such a snapshot may enable a customer to view data associated with the callback indication at the time the indication was generated. In examples, a customer may request customer information from a resource platform in response to receipt of a callback indication, which may be outdated or may otherwise differ from the information included in the callback indication (e.g., as a result of intervening changes).

It will be appreciated that a callback indication need not be limited to a single indication and, in some examples, multiple indications may be grouped into a single callback indication, as may be the case when multiple indications are generated contemporaneously or when previous indications were determined to be undeliverable to a customer device. In examples, a resource platform may retry when it is determined that a callback indication could not be provided to a customer device. For example, the resource platform may retry periodically after a predetermined amount of time has elapsed or may retry at progressively increasing intervals, among other examples.

Customer information may be maintained by a resource platform and/or by a customer, or a combination thereof. Example customer information includes, but is not limited to, information associated with one or more sender resources (e.g., sender account information and/or a quantity of available resources), recipients (e.g., recipient account information, tax information, and/or contact information), and historical transaction information, among other examples. As another example, customer information may comprise information associated with one or more entities, such as a company, a set of associated workplaces, a set of associated employees and/or contractors, one or more payrolls, and/or a set of benefits. Thus, while example information is described herein with respect to customers, senders, recipients, and transactions, it will be appreciated that alternative, additional, or less information may be managed by a resource platform and/or a customer according to aspects of the present disclosure.

In examples, the resource platform may provide an API and/or website through which aspects of the resource platform may be configured. For example, a customer may provide an indication to modify customer information via the API or website. Example modifications include, but are not limited to, updating company information, adding or removing an employee, or updating benefit information associated with the employee. In some instances, the resource platform may manage a workflow associated with an entity of the customer, for example to onboard a new employee, to request updated information (e.g., as may result from an expiration of existing information or a change in a set of conditions associated with transaction processing), or to renew or confirm a set of elected benefits.

Thus, the resource platform may receive information from and/or be configured by a customer device, perform processing based on the customer information (e.g., with or without involvement by the customer device, a recipient device, and/or one or more third-party services), and generate callback indications associated with such processing according to aspects described herein. In some instances, callback indications generated by a resource platform may be configurable, such that a customer device may receive only a subset of possible callback indications. For example, the customer may enable or disable a callback indication or may provide a set of conditions under which a callback indication should be generated. In some examples, the resource platform may enable a customer to view historical callback indications, such that the customer may provide an indication to re-generate a historical callback indication or may request additional information associated with a historical callback indication (e.g., for auditing or debugging purposes).

In some instances, the resource platform may process a transaction for a resource, such that a callback indication associated with the transaction is generated as a result of the processing performed by the resource platform. In other instances, the resource platform may utilize a third-party service to perform at least a part of such processing. For example, an indication of transaction information (e.g., relating to a sender and/or recipient) may be provided to the third-party service, thereby enabling the third-party service to process the transaction on behalf of the resource platform. As a result, an indication associated with processing the transaction may be received from the third-party service (e.g., that processing was successful, that processing failed, or that processing is suspended for additional information). The indication may be received as a callback indication from the third-party service or via an API of the resource platform, among other examples. Based on the indication received from the third-party service (or as a result of its processing of the transaction), the resource platform may perform additional processing, for example to update customer information and/or to generate a callback indication (e.g., to a customer device or a sender device), among other examples.

Thus, the resource platform may manage a lifecycle associated with transactions of a customer and may generate callback indication as described herein, for example relating to creation, drafting, and approval of a transaction (e.g., as may be performed in association with a customer device and/or a sender device). As another example, the resource platform may manage a transaction that is in a pending state, as may be the case after the transaction is approved but prior to transaction processing. Accordingly, the transaction may transition from a pending state to a processing state, for example according to a predetermined schedule or in response to an indication of manual input (e.g., as may be received from a customer device or a sender device). As a result of transitioning to the pending state, the resource platform may process the transaction. As noted above, processing the transaction may include processing by one or more third-party services in some examples. Eventually, the transaction may transition to a success state, a failed state, or a state indicating that additional information and/or user input is requested.

In examples, the resource platform may generate a status associated with an entity, for example indicating whether the entity can be party to a transaction or whether additional information is requested in association with the entity, among other examples.

As an example, a payable status may indicate whether an entity may be the recipient of a transaction. The payable status may be determined based on any of a variety of customer information, including information associated with the recipient and/or information associated with a sender. Returning to the above example, an employee may be determined to be payable once the customer information includes account information, tax information, and/or identification information for the employee. The resource platform may determine the payable status of an employee periodically and/or in response to an event, such as a change to information associated with the determination as to whether the employee is payable. A callback indication may be generated when the payable determination is made, as may be the case when it is determined that an employee is now payable. In some instances, a callback indication is generated as a result of the described determination, regardless of whether the employee has transitioned from not payable to payable, has transitioned from payable to not payable, or has remained either payable or not payable.

As another example, resources associated with a sender may be evaluated to determine whether the sender has sufficient resources to perform a transaction. For example, such a determination may be made according to a schedule and/or prior to processing transactions of the sender. The determination may comprise communicating with a third-party service to obtain resource information associated with a sender, for example relating to a quantity of resources or an account balance, among other examples. In instances where it is determined that the sender does not have sufficient resources, a callback indication may be generated to indicate that action is requested from the sender. In some instances, a callback indication may be generated even if it is determined that the sender has sufficient resources, thereby providing confirmation to a customer associated with the sender resources.

In a further example, a fraud determination may be made by the resource platform. The resource platform may evaluate information associated with a recipient to determine whether the recipient information exhibits one or more characteristics that may be indicative of fraud. The fraud determination may comprise evaluating the recipient information according to statistical and/or machine learning models (e.g., with respect to a larger group or population of recipients). In some instances, the fraud determination may comprise applying a hierarchical set of rules, such that evaluating the set of rules yields the fraud determination accordingly. Such a fraud determination may be performed periodically or in response to an event (e.g., a change in the recipient information or in advance of transaction processing). The result of the fraud determination may be provided as a callback indication according to aspects described herein.

While example dynamic determinations by a resource platform are provided above, it will be appreciated that any of a variety of alternative or additional determinations may be made by a resource platform based at least in part on information associated with a customer. In examples, such determinations may be configured by the customer, for example to enable or disable the above-described processing or to provide a set of rules, criteria, and/or models with which these and/or other determinations should be made.

As such, aspects of the present disclosure provide improved visibility into transaction processing associated with a resource platform, which may result in increased transaction throughput, improved user satisfaction, reduced system downtime, and improved reliability and accuracy, among other improvements.

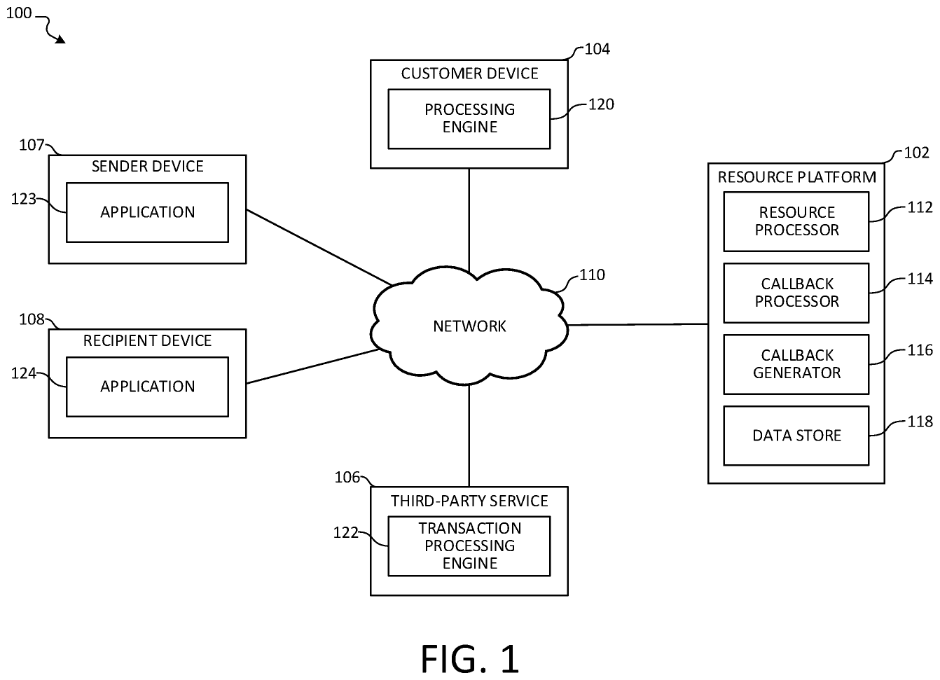

FIG. 1 illustrates an overview of an example system 100 for asynchronous transaction processing. As illustrated, system 100 comprises, and network 110. In examples, resource platform 102, customer device 104, third-party service 106, sender device 107, and recipient device 108 communicate via network 110. For example, network 110 may comprise a local area network, a wireless network, or the Internet, or any combination thereof, among other examples.

Customer device 104 and resource platform 102 may each be any of a variety of computing devices, such as one or more server computing devices Similarly, sender device 107 and recipient device 108 may each be any of a variety of computing devices, including, but not limited to, a server computing device, a desktop computing device, a laptop computing device, a tablet computing device, or a mobile computing device.

As illustrated, sender device 107 includes application 123 and recipient device 108 includes application 124. Application 123 and/or application 124 may each be associated with customer device 104 or resource platform 102. For example, a sender may use application 123 to configure resource transaction processing provided by customer device 104 and/or resource platform 102. As another example, a recipient or user of recipient device 108 may use application 124 to provide recipient information to resource platform 102, which may be stored in data store 118 as customer information. In some instances, recipient device 108 may use application 124 to provide the recipient information to customer device 104, which may ultimately provide the customer information to resource platform 102 accordingly. In other examples, the recipient uses application 124 to view associated resources, which may include one or more resources received from a sender (e.g., as may be associated with sender device 107). In a further example, customer device 104 may maintain at least a part of the customer information, such that it need not be provided for storage by resource platform 102.

Customer device 104 includes processing engine 120, which may provide an indication to resource platform 102 to transfer a resource. In examples, processing engine 120 provides the indication based on user input received at sender device 107, as may be received as a result of a sender specifying a one-off or recurring transaction, among other examples. Thus, as noted above, customer device 104 is associated with a customer that uses resource platform 102 to provide transaction processing services. In examples, sender device 107 and customer device 104 need not be separate devices, as may be the case when a sender and a customer are the same. For instance, a customer may be a sender that requests the transfer of a resource to a recipient using resource platform 102. In other examples, resource platform 102 may communicate more directly with sender device 107 and/or recipient device 108 to provide transaction processing accordingly.

In some examples, customer device 104 communicates with resource platform 102 on behalf of sender device 107 and/or recipient device 108, such that sender device 107 and/or recipient device 108 need not communicate with resource platform 102 itself. In such an example, resource platform 102 provides callback indications to customer device 104, thereby enabling customer device 104 to process the callback indications accordingly (e.g., to provide a subsequent indication to sender device 107 and/or recipient device 108). In other examples, resource platform 102 may communicate more directly with sender device 107 and/or recipient device 108. As an example, resource platform 102 may receive an indication to process a transaction from customer device 104, such that a callback indication associated with the may be provided to sender device 107 and/or recipient device 108, among other examples. Thus, a callback indication may be provided to the same device that initiated processing associated with the callback indication or may be provided to a different device, or a combination thereof.

As illustrated, resource platform 102 comprises resource processor 112, callback processor 114, callback generator 116, and data store 118. In examples, resource processor 112 processes requests associated with an API and/or website of resource platform 102, for example to configure callbacks and/or update customer information for a customer associated with customer device 104 as described above. Resource processor 112 may update information associated with the customer in data store 118 accordingly. Additionally, resource processor 112 may make dynamic determinations associated with one or more entities of data store 118, for example relating to payable status, resource sufficiency, and/or suspected fraud. In such instances, resource processor 112 may provide an indication of its determination to callback generator 116, such that a callback indication may be generated accordingly.

Callback processor 114 may process callback indications received by resource platform 102, as may be received from third-party service 106. For example, third-party service 106 may be a transaction processor that resource platform 102 uses to process transactions. In such an example, resource platform 102 may provide an indication to process a transaction to third-party service 106, such that transaction processing engine 122 may transfer one or more resources of a sender (e.g., as may be associated with sender device 107) to a recipient (e.g., as may be associated with recipient device 108). Accordingly, transaction processing engine 122 may provide an indication to resource platform 102, which may be processed by callback processor 114. For example, callback processor 114 may update customer information in data store 118.

Resource platform 102 is further illustrated as including callback generator 116, which generates callback indications according to aspects described herein. For example, callback generator 116 may generate a callback indication as a result of a callback indication from third-party service 106 (e.g., as may be processed by callback processor 114). The generated callback indication may be provided to customer device 104, such that processing engine 120 processes the callback indication accordingly. For example, processing engine 120 may provide an indication of a successful or failed transaction to sender device 107 and/or recipient device 108, among other examples.

As noted above, callback generator 116 may generate callback indications in any of a variety of instances and having any of a variety of content. For example, callback generator 116 may generate a callback indication that indicates a status of a transaction, when customer information in data store 118 changes, and/or when a dynamic state of an entity is determined to have changed. Callback generator 116 may obtain callback target information from data store 118 (e.g., as may be specified as a result of API interactions between customer device 104 and resource processor 112), which may indicate a target or destination to which a callback should be directed. For example, the callback target information may indicate customer device 104 as the target for a callback indication. In examples, customer device 104 may include a webserver and have an associated URL, such that the callback target information directs generated callback indications to the webserver accordingly.

In examples, callback generator 116 may determine whether a callback indication should be generated, for example as may be configured by a customer or as may be determined based on an associated context, among other examples. As a further example, callback generator 116 may include a cryptographic signature or hash in a generated callback indication. For example, resource processor 112 may generate a cryptographic key when a callback is configured by customer device 104, such that the cryptographic key is stored in data store 118 and provided to customer device 104. Accordingly, the callback target information obtained by callback generator 116 may include the cryptographic key, such that the signature and/or hash is generated and included in the generated callback indication.

It will be appreciated that any of a variety of cryptographic and/or hashing techniques may be used. For example, asymmetric or symmetric cryptography may be used, where a public key is provided to customer device 104 and a private key is stored in data store 118. In other examples, resource processor 112 may not generate a cryptographic key and a cryptographic key may instead be received from a remote device. For instance, customer device 104 may generate a cryptographic key pair, such that a public key is received by resource processor 112 and stored in data store 118, while an associated private key is maintained by customer device 104. It will be appreciated that such aspects are not mutually exclusive.

As another example, a callback indication may include an idempotency value usable by the recipient device to determine whether the callback indication has been previously received. For example, if a callback indication is retried, the recipient device may receive the same callback indication twice. Accordingly, the idempotency value enables the recipient to identify such instances and avoid performing duplicative processing. Example idempotency values include, but are not limited to, a serial number or a unique identifier.

In examples, resource platform 102 maintains a set of conditions associated with processing resource transactions. For example, the set of conditions may be regional and/or may depend on an industry associated with a sender. In some instances, at least a part of the set of conditions may be specified by a customer or sender (e.g., as may result from indications from customer device 104 and/or sender device 107, respectively). Example conditions include, but are not limited to, criteria associated with recipient information (e.g., tax requirements or employment eligibility requirements) and criteria associated with sender information (e.g., legal requirements or reporting requirements).

In examples, a condition may change, such that callback generator 116 determines at least a part of the customer information fails to satisfy the changed condition. For example, the information may be nonexistent, may be out of date, may be incorrect, or may be noncompliant. As a result, callback generator 116 may generate a callback indication that provides an indication as to the changed condition and/or requests information to resolve the identified issue, among other examples.

When callback generator 116 generates a callback indication, a record of the generated callback indication may be stored in data store 118, thereby enabling a customer to view its associated historical callback indications. Thus, resource processor 112 may provide at least a part of a customer's historical callback indications (e.g., to customer device 104 and/or to sender device 107) for display to a user. In examples, resource processor 112 may receive an indication to resend a callback indication, such that resource processor 112 may instruct callback generator 116 to resend the specified callback indication accordingly.

It will be appreciated that resource platform 102 may be implemented according to any of a variety of paradigms. As noted above, resource platform 102 may be a distributed computing device, including multiple server computing devices. In some instances, resource platform 102 may be implemented using a “serverless” paradigm, in which aspects of resource processor 112, callback processor 114, and callback generator 116 are provided by executing associated software on an as-needed basis. In such instances, data may be obtained from data store 118 and processed using the associated software (e.g., to generate callback indications and/or update data in data store 118), at which point the processing may be terminated or suspended until subsequent processing is performed. For example, such processing may be performed in response to a request from customer device 104 and/or in response to an indication from third-party service 106. As another example, such processing may be performed according to a predetermined schedule. In examples, a queue may be used to perform such processing, where events are added to the queue and processed accordingly as described above. Multiple queues may be maintained, for example for each customer of resource platform 102. Such aspects may enable the processing described herein to be performed with reduced utilization of computational resources, as may be the case when processing by a resource platform is inconsistent or cyclical, among other examples.

While system 100 is illustrated as comprising one customer device 104, one third-party service 106, one sender device 107, one recipient device 108, and one resource platform 102, it will be appreciated that, in other examples, any number of such elements may be used. Further, it will be appreciated that functionality described above with respect to specific elements of system 100 may be distributed according to any of a variety of other paradigms in other examples. For example, resource platform 102 may provide resource processing functionality for any number of customers and/or associated customer devices.

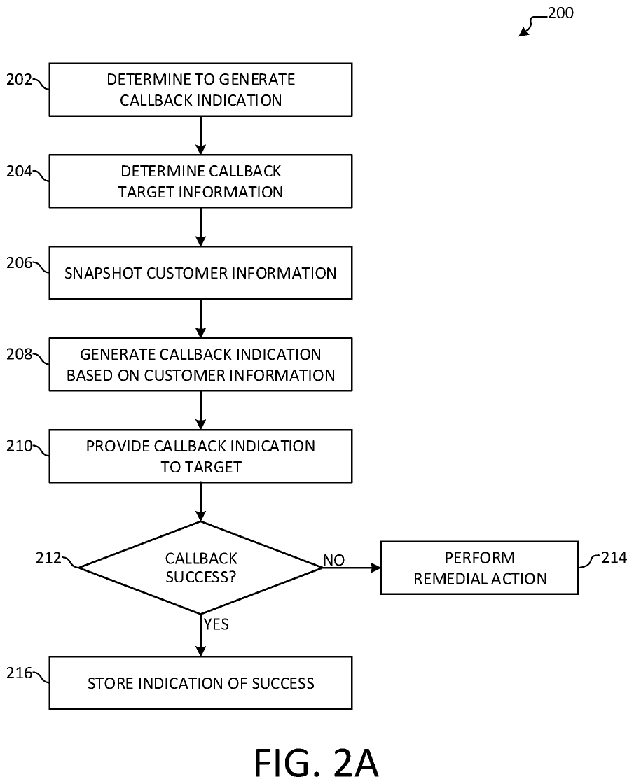

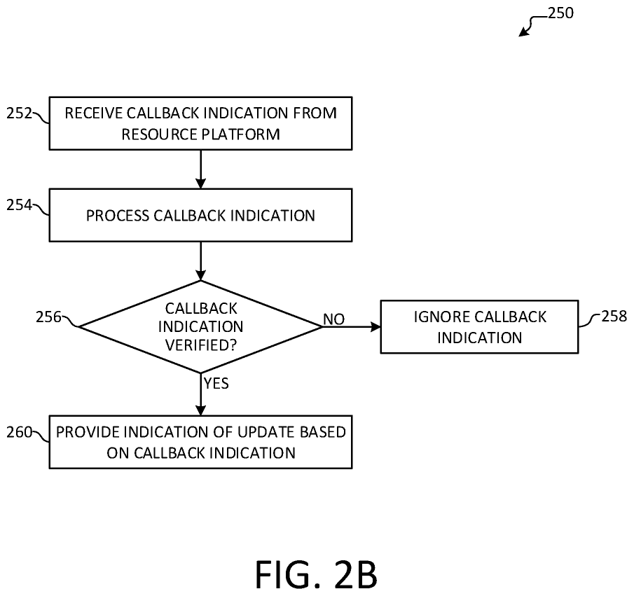

FIG. 2A illustrates an overview of an example method 200 for generating a callback indication associated with asynchronous transaction processing. In examples, aspects of method 200 are performed by a resource platform, such as resource platform 102 in FIG. 1.

Method 200 begins at operation 202, where it is determined to generate a callback indication. For example, it may be determined to generate a callback indication based on a change to customer information in a data store (e.g., data store 118 in FIG. 1), as may occur as a result of interactions with a customer device, sender device, and/or recipient device (e.g., customer device 104, sender device 107, and/or recipient device 108, respectively). In other examples, it may be determined to generate a callback indication as a result of an indication received from a third-party service, such as third-party service 106. In some instances, it may be determined to generate a callback indication as a result of a predetermined time period having elapsed or based on a status determination, among other examples. As another example, operation 202 may comprise evaluating a preference indicating whether a type of callback indication should be generated (e.g., as may be set by a customer). Thus, it will be appreciated that a callback indication may be generated in any of a variety of contexts.

Flow progresses to operation 204, where callback target information is determined. For example, operation 204 may comprise identifying the callback target information in a data store, as may be associated with a customer of the resource platform. In examples, the callback target information is determined based on a type of callback indication and/or an entity associated with the callback indication that is to be generated. For example, different callback target information may be used for a callback indication indicating success as compared to a callback indication that indicates failure.

Flow progresses to operation 206, where a snapshot is generated for customer information. In examples, the snapshot generated at operation 206 includes a subpart of the customer information, such as customer information that is associated with the callback indication that was determined to be generated at operation 202. For example, the snapshot may include an indication as to an entity associated with the callback indication and/or one or more changes to the customer information for which the callback indication is being generated. In some instances, information that is included or omitted from a generated snapshot may be configurable, for example via an API provided by the resource platform.

At operation 208, a callback indication is generated based on the customer information that was snapshotted at operation 206, which may be included as the content of the callback indication. For example, the callback indication may include a cryptographic signature and/or hash. In such an example, the callback target information obtained at operation 204 may include information usable to generate the signature, such as a cryptographic key.

Moving to operation 210, the callback indication is provided to the target. In an example where the callback indication is a webhook, the callback indication may be provided as hypertext transport protocol (HTTP) request to a URL indicated by the callback target indication. In such an example, the request may be encrypted using transport layer security (TLS; e.g., via HTTPS). A cryptographic signature generated at operation 208 may be included as a header of the request. As another example, the callback indication may include an idempotency value usable by the recipient device to determine whether the callback indication has been previously received. For example, if a callback indication is retried, the recipient device may receive the same callback indication twice. Accordingly, the idempotency value enables the recipient to identify such instances and avoid performing duplicative processing. While example techniques for generating and providing a callback indication are described, it will be appreciated that any of a variety of techniques may be used according to aspects described herein.

At determination 212, it is determined whether the callback indication was provided successfully. In examples, operation 210 may result in an error or may timeout, as may be the case when the callback target information includes an outdated or incorrect URL, or when a customer device is unavailable (e.g., as a result of a system failure or a network failure), among other examples.

Accordingly, if it is determined that operation 210 was not successful, flow branches “NO” to operation 214, where a remedial action is performed. Example remedial actions include, but are not limited to, generating an error callback indication (e.g., using different callback target information) and/or retrying aspects of method 200 at a later time. For example, the resource platform may repeatedly attempt providing the callback indication after a predetermined amount of time has elapsed, where the predetermined amount of time may be substantially constant or may gradually or exponentially increase with subsequent failures. While example remedial actions are provided, it will be appreciated that any of a variety of alternative or additional actions may be performed at operation 214. Method 200 terminates at operation 214.

If, however, it is instead determined that operation 210 was successful at determination 212, method 200 branches “YES” to operation 216, where an indication of the success is stored. For example, information associated with the callback indication may be stored in a data store, thereby enabling later auditing and/or debugging associated with the callback indication. Method 200 terminates at operation 216.

FIG. 2B illustrates an overview of an example method 250 for processing a callback indication associated with asynchronous transaction processing. In examples, aspects of method 250 are performed by a recipient of a callback indication, such as customer device 104 discussed above with respect to FIG. 1.

Method 250 begins at operation 252, where a callback indication is received from a resource platform (e.g., resource platform 102 in FIG. 1). As an example, the callback indication may be received by a webserver as a webhook, where the callback indication is provided to a URL associated with the webserver. As another example, the callback indication may be received as an API call, among other examples. As discussed above, the callback indication may comprise a snapshot of customer information from the resource platform.

Flow progresses to operation 254, where the callback indication is processed. For example, operation 254 comprises parsing the callback indication, as may be the case when the content comprises one or more objects according to the JavaScript Object Notation (JSON) format. In examples, operation 254 further comprises generating a cryptographic signature and/or hash for the callback indication.

At determination 256, it may be determined whether the callback indication is verified. For example determination 256 may comprise comparing a cryptographic signature and/or hash that was generated at operation 254 with a cryptographic signature and/or hash that was included in the callback indication that was received at operation 252. Accordingly, if it is determined that the callback indication is not verified, flow branches “NO” to operation 258, where the callback indication is ignored. As another example, if an idempotency value is determined to indicate that the callback indication has been previously processed, flow may similarly branch “NO” to operation 258. Thus, rather than processing the callback indication at operation 260, the callback indication may be discarded, such that no updates or other processing occurs. In other examples, an indication that the callback indication failed verification may be provided, as may be stored in a data store and/or provided for a user. Method 250 terminates at operation 258.

If, however, it is instead determined that the callback indication is verified, flow branches “YES” to operation 260, where an indication of an update is provided based on the received callback indication. For example, operation 260 may comprise performing one or more actions as a result of the received callback indication, such as providing an indication to a sender and/or recipient device (e.g., sender device 107 and/or recipient device 108 in FIG. 1) or updating information associated with the callback indication. In some instances, operation 260 may include requesting updated customer information from the resource platform, as may the information stored by the resource platform may have changed since the callback indication was generated, received, or queued for generation by the resource platform, among other examples. Method 250 terminates at operation 260.

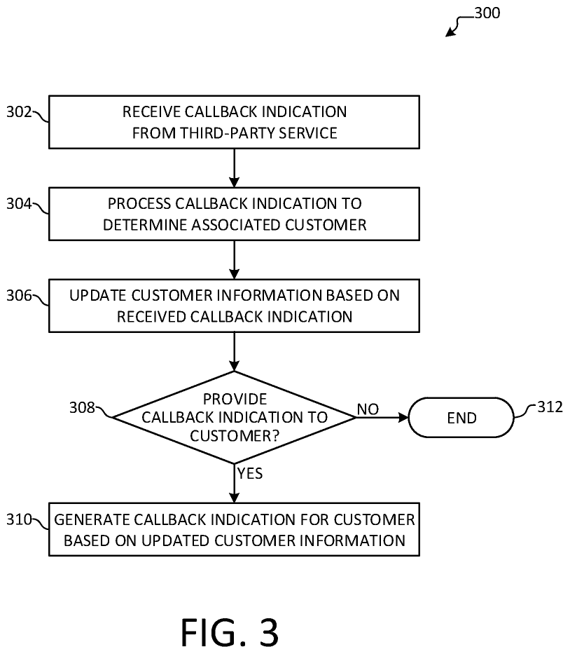

FIG. 3 illustrates an overview of an example method 300 for processing a callback indication from a third-party service by a resource platform according to aspects described herein. In examples, aspects of method 300 are performed by a resource platform, such as resource platform 102 discussed above with respect to FIG. 1.

Method 300 begins at operation 302, where a callback indication is received from a third-party service. For example, the callback indication may be received from third-party service 106. In examples, the resource platform may communicate with one or more third-party services to perform transaction processing according to aspects described herein. Accordingly, the callback indication received from the third-party service may be associated with processing a transaction, for example providing an indication that a transaction was successfully processed, that a failure occurred, or that additional information and/or manual interaction is being requested, among other examples. While aspects are described herein with respect to transaction processing by a third-party service, it will be appreciated that any of a variety of additional or alternative functionality may be provided by a third-party service, such as identity verification of a sender and/or recipient. Further, while method 300 is described in an example where a callback indication is received, it will be appreciated that similar techniques may be used for any of a variety of other types of indications.

At operation 304, the callback indication is processed to determine an associated customer. For example, operation 304 may be performed in instances where a resource platform provides functionality for multiple customers. In examples, operation 304 comprises determining a URL via which the callback indication was received. As another example, the associated customer may be determined based on content of the received callback indication.

Flow progresses to operation 306, where customer information is updated based on the received callback indication, as may be stored by a data store (e.g., data store 118 in FIG. 1). For example, the customer information may be updated to transition a transaction from pending to successful, among other transitions associated with a transaction lifecycle (examples of which were discussed above). In some instances, method 300 may include aspects similar to operations 256 and 258, such that customer information updates are performed once the callback indication is verified.

Moving to determination 308, it is determined whether a callback indication should be provided to the determined customer. For example, determination 308 may include evaluating one or more preferences specified by the customer. In some instances, the determination may made based on the customer information that was updated, such that an callback indication may not be provided if an update is associated with a given entity type or if a transaction was successful. In such an example, a callback indication may instead be provided if a transaction was not successful or additional information and/or manual input is requested. Accordingly, if it is determined not to provide a callback indication, flow branches “NO” and terminates at operation 312.

By contrast, if it is determined to provide a callback indication to the customer, flow instead branches “YES” to operation 310, where a callback indication is generated based on the updated customer information. Aspects of operation 310 may be similar to those discussed above with respect to method 200 of FIG. 2A and are therefore not re-described below in detail. Method 300 terminates at operation 310.

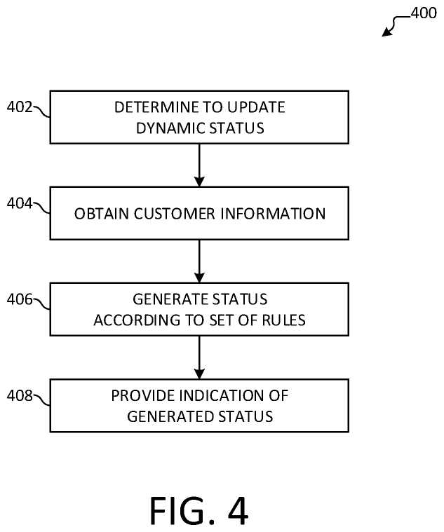

FIG. 4 illustrates an overview of an example method 400 for generating a dynamic status associated with a customer according to aspects described herein. In examples, aspects of method 400 are performed by a resource platform, such as resource platform 102 discussed above with respect to FIG. 1. For example, aspects of method 400 may be performed to update a payable status associated with an employee, make a resource sufficiency determination, and/or to make a fraud determination, among other examples.

Method 400 begins at operation 402, where it is determined to update a dynamic status. In examples, operation 402 determines to update the dynamic status as a result of identifying a change to customer information associated with the dynamic status. For example, a dynamic status may have an associated set of rules from which the dynamic status is calculated, such that a change to the rules and/or to information associated with evaluating one or more rules may result in a change to the dynamic status. In other examples, the dynamic status may be re-determined periodically, among other examples.

At operation 404, customer information is obtained, for example from a data store and/or from a third-party service, among other examples. For example, the customer information may be obtained based on the information needed to evaluate the set of criteria associated with the dynamic status. Flow progresses to operation 406, where a set of rules is used to generate the dynamic status accordingly. While method 400 is described in the context of evaluating a set of rules to generate the dynamic status, it will be appreciated that any of a variety of other techniques may be used to generate the dynamic status, such as a set of conditions or a trained classifier, among other examples.

At operation 408, an indication of the generated status is provided. For example, the indication may be provided to a data store, such that the updated dynamic status is stored as customer information. As another example, the indication may be provided as a callback indication (e.g., according to aspects of method 200 discussed above with respect to FIG. 2A). In examples, operation 408 includes a determination as to whether the dynamic status has changed, such that an indication may be provided based on determining that the dynamic status has changed. Method 400 terminates at operation 408.

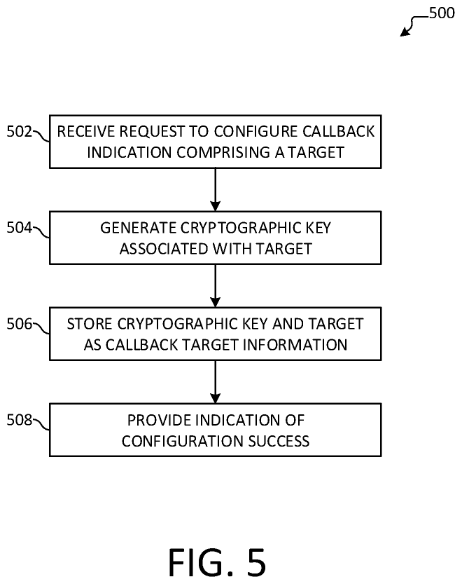

FIG. 5 illustrates an overview of an example method 500 for configuring a callback indication with which aspects of asynchronous transaction processing may be performed. For example, aspects of method 500 may be performed by a resource platform (e.g., resource platform 102 discussed above with respect to FIG. 1) as a result of an interaction by a customer device (e.g., customer device 104) or a sender device (e.g., sender device 107).

Method 500 begins at operation 502, where a request is received to configure a callback indication. In examples, the request includes an indication of a callback target, such as a URL or an API call to be used to provide the callback indication.

At operation 504, a cryptographic key is generated, which may be associated with the target. For example, a symmetric cryptographic key or an asymmetric cryptographic key pair may be generated at operation 504. In some instances, operation 504 may be omitted, as may be the case when the request received at operation 502 includes a cryptographic key or when a pre-existing cryptographic key is to be used. For example, a customer may have a cryptographic key that is used for multiple callback indications.

Flow progresses to operation 506, where the cryptographic key and target are stored in a data store as callback target information. In instances where a pre-existing key is used, operation 506 need not include storing the cryptographic key as callback target information. The callback target information may be stored in association with a given customer and, in some examples, may be associated with one or more types of callback indications.

At operation 508, an indication of configuration success is provided in response to the request that was received at operation 502. For example, the indication may comprise at least a part of the cryptographic key that was generated at operation 504. In examples, the indication may comprise testing the callback target information, such that a test callback indication is provided using the callback target information accordingly. Method 500 terminates at operation 508.

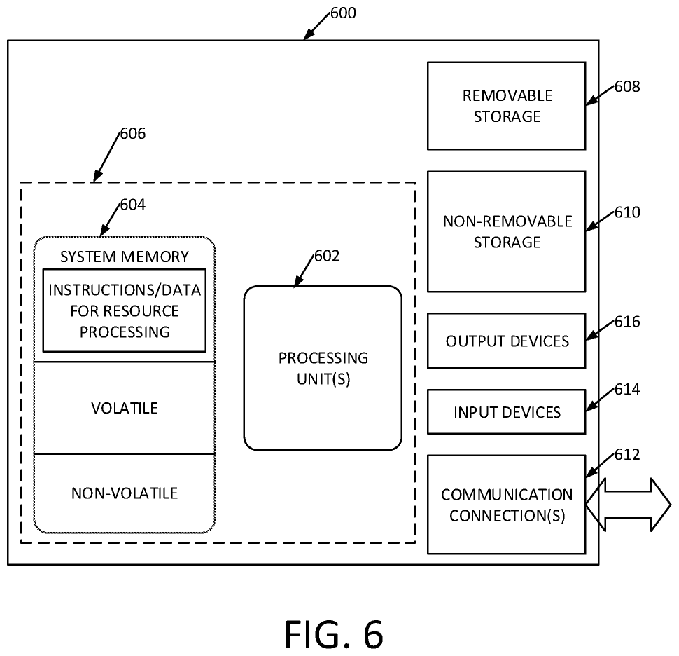

FIG. 6 illustrates an example of a suitable operating environment 600 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 600 typically may include at least one processing unit 602 and memory 604. Depending on the exact configuration and type of computing device, memory 604 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as a keyboard, mouse, pen, voice input, etc. and/or output device(s) 616 such as a display, speakers, printer, etc. Also included in the environment may be one or more communication connections, 612, such as LAN, WAN, point to point, etc.

Operating environment 600 may include at least some form of computer readable media. The computer readable media may be any available media that can be accessed by processing unit 602 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 604. While executing on the processing unit 602, program modules (e.g., applications, Input/Output (I/O) management, and other utilities) may perform processes including, but not limited to, one or more of the stages of the operational methods described herein such as the methods discussed with respect to FIG. 1, 2A, 2B, 3, 4, or 5, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 600 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, causes the system to perform a set of operations. The set of operations comprises: determining to generate a callback indication associated with a customer of a resource platform; and in response to determining to generate the callback indication: obtaining callback target information associated with a customer computing device of the customer; generating the callback indication comprising a snapshot of at least a part of customer information associated with the customer; and providing, based on the callback target information, the generated callback indication to the customer computing device. In an example, determining to generate the callback indication is based on at least one of: receiving another callback indication from a third-party service; identifying an update to the customer information; identifying in a change to a set of conditions associated with the customer; determining a predetermined amount of time has elapsed; or determining a dynamic status based on the customer information. In another example, the another callback indication from the third-party service indicates a transaction status for a transaction processed by the third-party service. In a further example, the callback target information includes a uniform resource locator (URL) associated with the customer computing device. In yet another example, the callback target information further includes a cryptographic key; generating the callback indication comprises generating a cryptographic hash of content of the callback indication; and providing the generated callback indication comprises providing the generated cryptographic hash. In a further still example, the set of operations further comprises: identifying a failure to provide the generated callback indication to the customer computing device; and in response to identifying the failure, providing the generated callback indication to the customer computing device after a predetermined time period has elapsed. In another example, the set of operations further comprises: receiving, from the customer computing device, a request for at least a part of the customer information associated with the customer.

In another aspect, the technology relates to a method for processing customer information by a resource platform. The method comprises: receiving, from a third-party service, a first callback indication that indicates a transaction status for a transaction processed by the third-party service; processing the first callback indication to update the customer information associated with a customer of the resource platform; obtaining callback target information associated with a customer computing device of the customer; generating a second callback indication comprising a snapshot of at least a part of the updated customer information; and providing, based on the callback target information, the second callback indication to the customer computing device. In an example, the method further comprises: providing an indication to the third-party service to process the transaction, wherein: the transaction is between a sender and a recipient; and the customer information includes recipient information indicative of a payable status for the recipient. In another example, the callback target information includes a cryptographic key; generating the second callback indication comprises generating a cryptographic hash of content of the second callback indication; and providing the second callback indication comprises providing the generated cryptographic hash. In a further example, the method further comprises: identifying a failure to provide the generated callback indication to the customer computing device; and in response to identifying the failure, providing the generated callback indication to the customer computing device after a predetermined time period has elapsed. In yet another example, the method further comprises: receiving, from the customer computing device, a request for at least a part of the customer information associated with the customer. In a further still example, the callback target information includes a uniform resource locator (URL) associated with the customer computing device.

In a further aspect, the technology relates to a method for processing customer information by a resource platform. The method comprises: determining to generate a callback indication associated with a customer of a resource platform; and in response to determining to generate the callback indication: obtaining callback target information associated with a customer computing device of the customer; generating the callback indication comprising a snapshot of at least a part of customer information associated with the customer; and providing, based on the callback target information, the generated callback indication to the customer computing device. In an example, determining to generate the callback indication is based on at least one of: receiving another callback indication from a third-party service; identifying an update to the customer information; identifying in a change to a set of conditions associated with the customer; determining a predetermined amount of time has elapsed; or determining a dynamic status based on the customer information. In another example, the another callback indication from the third-party service indicates a transaction status for a transaction processed by the third-party service. In a further example, the callback target information includes a uniform resource locator (URL) associated with the customer computing device. In yet another example, the callback target information further includes a cryptographic key; generating the callback indication comprises generating a cryptographic hash of content of the callback indication; and providing the generated callback indication comprises providing the generated cryptographic hash. In a further still example, the method further comprises: identifying a failure to provide the generated callback indication to the customer computing device; and in response to identifying the failure, providing the generated callback indication to the customer computing device after a predetermined time period has elapsed. In another example, the method further comprises: receiving, from the customer computing device, a request for at least a part of the customer information associated with the customer.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
determining to generate a callback indication associated with a customer of a resource platform; and
in response to determining to generate the callback indication:
obtaining callback target information associated with a customer computing device of the customer;
generating the callback indication comprising a snapshot of at least a part of customer information associated with the customer; and
providing, based on the callback target information, the generated callback indication to the customer computing device.

2. The system of claim 1, wherein determining to generate the callback indication is based on at least one of:
receiving another callback indication from a third-party service;
identifying an update to the customer information;
identifying in a change to a set of conditions associated with the customer;
determining a predetermined amount of time has elapsed; or determining a dynamic status based on the customer information.

3. The system of claim 2, wherein the another callback indication from the third-party service indicates a transaction status for a transaction processed by the third-party service.

4. The system of claim 1, wherein the callback target information includes a uniform resource locator (URL) associated with the customer computing device.

5. The system of claim 4, wherein:
the callback target information further includes a cryptographic key;
generating the callback indication comprises generating a cryptographic hash of content of the callback indication; and
providing the generated callback indication comprises providing the generated cryptographic hash.

6. The system of claim 1, wherein the set of operations further comprises:
identifying a failure to provide the generated callback indication to the customer computing device; and
in response to identifying the failure, providing the generated callback indication to the customer computing device after a predetermined time period has elapsed.

7. The system of claim 1, wherein the set of operations further comprises:
receiving, from the customer computing device, a request for at least a part of the customer information associated with the customer.

8. A method for processing customer information by a resource platform, comprising:
receiving, from a third-party service, a first callback indication that indicates a transaction status for a transaction processed by the third-party service;
processing the first callback indication to update the customer information associated with a customer of the resource platform;
obtaining callback target information associated with a customer computing device of the customer;
generating a second callback indication comprising a snapshot of at least a part of the updated customer information; and
providing, based on the callback target information, the second callback indication to the customer computing device.

9. The method of claim 8, further comprising:
providing an indication to the third-party service to process the transaction, wherein:
the transaction is between a sender and a recipient; and
the customer information includes recipient information indicative of a payable status for the recipient.

10. The method of claim 8, wherein:
the callback target information includes a cryptographic key;
generating the second callback indication comprises generating a cryptographic hash of content of the second callback indication; and
providing the second callback indication comprises providing the generated cryptographic hash.

11. The method of claim 8, further comprising:
identifying a failure to provide the generated callback indication to the customer computing device; and
in response to identifying the failure, providing the generated callback indication to the customer computing device after a predetermined time period has elapsed.

12. The method of claim 8, further comprising:
receiving, from the customer computing device, a request for at least a part of the customer information associated with the customer.

13. The method of claim 8, wherein the callback target information includes a uniform resource locator (URL) associated with the customer computing device.

14. A method for processing customer information by a resource platform, comprising:
determining to generate a callback indication associated with a customer of a resource platform; and
in response to determining to generate the callback indication:
obtaining callback target information associated with a customer computing device of the customer;
generating the callback indication comprising a snapshot of at least a part of customer information associated with the customer; and
providing, based on the callback target information, the generated callback indication to the customer computing device.

15. The method of claim 14, wherein determining to generate the callback indication is based on at least one of:
receiving another callback indication from a third-party service;
identifying an update to the customer information;
identifying in a change to a set of conditions associated with the customer;
determining a predetermined amount of time has elapsed; or determining a dynamic status based on the customer information.

16. The method of claim 15, wherein the another callback indication from the third-party service indicates a transaction status for a transaction processed by the third-party service.

17. The method of claim 14, wherein the callback target information includes a uniform resource locator (URL) associated with the customer computing device.

18. The method of claim 17, wherein:
the callback target information further includes a cryptographic key;
generating the callback indication comprises generating a cryptographic hash of content of the callback indication; and
providing the generated callback indication comprises providing the generated cryptographic hash.

19. The method of claim 14, further comprising:
identifying a failure to provide the generated callback indication to the customer computing device; and
in response to identifying the failure, providing the generated callback indication to the customer computing device after a predetermined time period has elapsed.

20. The method of claim 14, further comprising:
receiving, from the customer computing device, a request for at least a part of the customer information associated with the customer.
